(19) United States
(12) Patent Application Publication
(10) Pub. No.: US 2022/0205494 A1
(43) Pub. Date: Jun. 30, 2022

(54) INTERIOR CLUTCH-USED CONTROL MECHANISM

(71) Applicant: JEN-CHIH Lyang LIU, Kaohsiung Hsien (TW)

(72) Inventor: JEN-CHIH Lyang LIU, Kaohsiung Hsien (TW)

(21) Appl. No.: 17/696,897

(22) Filed: Mar. 17, 2022

Related U.S. Application Data
(63) Continuation-in-part of application No. 16/984,127, filed on Aug. 3, 2020.

(51) Int. Cl. F16D 41/30

(52) U.S. Cl. CPC F16D 41/30; B62M 11/14

(57) ABSTRACT

An interior clutch-used control mechanism comprises a driving rod being installed on a center shaft of an internal clutch; a control claw actuating seat and a rotation ring being installed at an outer side of the center shaft; the control claw actuating seat being positioned at a center of the rotation ring; an inner side of the rotation ring being installed with a plurality of upper planet power ratchet claws and lower planet power ratchet claws; a ratchet claw control panel being installed at an inner side of the upper and lower planet power ratchet claws; the ratchet claw control panel being installed with a plurality of left control claws and right control claws; and the left and right control claws being installed on the ratchet claw control panel and being driven by the ratchet claw control panel to rotate.

The present invention is an application of continuation in part (CIP) of U.S. patent application Ser. No. 16/984,127, filed at Aug. 3, 2020, which is invented by and assigned to the applicant of the present invention, and thus the contents of the U.S. patent application Ser. No. 16/984,127 are incorporated into the present invention as a part of the present invention.

### FIELD OF THE INVENTION

The present invention relates to a bicycle internal clutch, and in particular to a interior clutch-used control mechanism.

### BACKGROUND OF THE INVENTION

The control mechanism of an internal clutch of a bicycle is complex and thus is heavy, large volume, and expensive. Meanwhile, it is insensitive in operation so as to deteriorate the quality of the clutch and the bicycle. Therefore, it is eager to develop and improve the prior art internal clutch of a bicycle.

Other than the designs of gears and paths of the internal clutch, to improve the driving rods and other structural elements of the internal clutches has related to the structures, weights and costs, and sensitivity and preciseness in controlling and the speed of change gears. Therefore, there is an eager demands to have an internal clutch with a the simple structures, light weights and low costs, and high sensitivity, high preciseness in controlling, fast speed in changing gears.

### SUMMARY OF THE INVENTION

The present invention relates to bikes, and in particular to a interior clutch-used control mechanism, in that, by power rotating components (such as input rings, inner gears planet frames, output rings, etc.) which rotates as the internal clutch and cam or cam-like component, clutching components are controlled. That is, using a cam or cam-like components to drive a driven device to rotate or displace so as to control the clutch to change gears. The internal clutch is commonly used to chainless bikes and chain contained bikes; has the advantages of saving storage space, light weight, low cost, high usages in industry. Furthermore the structure of the internal clutch is simple so that the efficiencies in assembly and repair are promoted. In the present invention by power rotating components (such as input rings, inner gears planet frames, output rings, etc.) which rotates as the internal clutch and cam or cam-like component, clutching components are controlled, such as to control the fixing of a sun gear, to control the engagements of the internal gear and planet gear. That is, using a cam or cam-like components to drive a driven device to rotate or displace so as to control the clutch to change gears

To achieve above object, the present invention provides an interior clutch-used control mechanism comprises a driving rod being installed on a center shaft of an internal clutch; a control claw actuating seat and a rotation ring being installed at an outer side of the center shaft; the rotation ring being used as a power rotation unit; the control claw actuating seat being positioned at a center of the rotation ring; an inner side of the rotation ring being installed with a plurality of claw shafts for being assembled to a plurality of upper planet power ratchet claws and a plurality of lower planet power ratchet claws; each of the upper planet power ratchet claws being connected to a respective one claw shaft each of the lower planet power ratchet claws being connected to a respective one claw shaft; a ratchet claw returning spring surrounding an outside of the claw shafts; a ratchet claw control panel being installed at an inner side of the upper planet power ratchet claws and the lower planet power ratchet claws; the ratchet claw control panel being used as a linking device; the ratchet claw control panel being installed with a plurality of left control claws and a plurality of right control claws and a plurality of controlling claw shafts; each of the left control claws being connected to a respective one controlling claw shaft; each of the right control claws being connected to a respective one controlling claw shafts; and a claw returning spring being installed at an inner side of the controlling claw shafts; the left control claws and the right control claws being positioned and installed on the ratchet claw control panel and being driven by the ratchet claw control panel to rotate.

### BRIEF DESCRIPTION OF DRAWINGS

FIG. 1 is a partial assembly view of an internal clutch of a bike of the present invention.

FIG. 1A is a cross sectional view about an internal clutch for a bike of the present invention.

FIG. 2 is a cross sectional view that a sun gear is fixed to or freely displacement with respect to the axial clutching control unit.

FIG. 2A is an exploded view of the clutch shown in FIG. 2.

FIG. 3 is a cross sectional view about the axial separation control unit of FIG. 2.

FIG. 4 is a cross sectional view showing that a sun gear is fixed to or freely displacement with respect to the axial clutching control unit.

FIG. 5 is a schematic view showing the action of the claws of the radial separation control unit of FIG. 4.

FIG. 6 is a schematic view showing the claw operation for controlling the fixedness of the sun gear.

FIG. 7 is a cross sectional showing the control unit for the inner gears at two sides and the planet frame according to the present invention.

FIG. 7A is an exploded view of the structure shown in FIG. 7.

FIG. 8 is a schematic view showing the closing operation about the clutching claw.

FIG. 9 is a cross sectional view showing a embodiment, in that a control claw of a control unit is positioned on a fixing unit.

FIG. 9A is an exploded view of the structure shown in FIG. 9.

FIG. 10 is a schematic view about the operation of the clutching claw of FIG. 9.

FIG. 11 is a cross sectional view showing an embodiment of the present invention, in that a control unit is used to a axial clutching operation.

FIG. 11A is an exploded view of the structure shown in FIG. 11.

FIG. 12 is a cross sectional view showing an embodiment of the present invention, in that a control unit is used to a radial clutching operation.

### BRIEF DESCRIPTION OF THE INVENTION

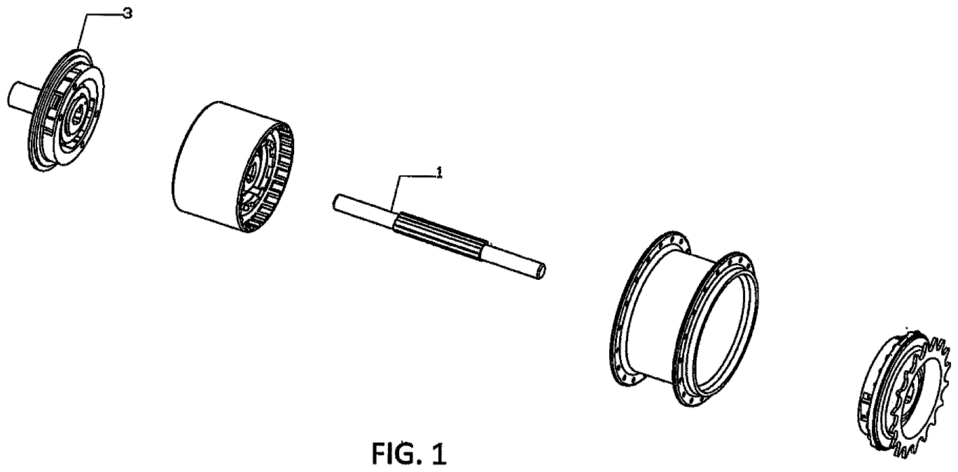

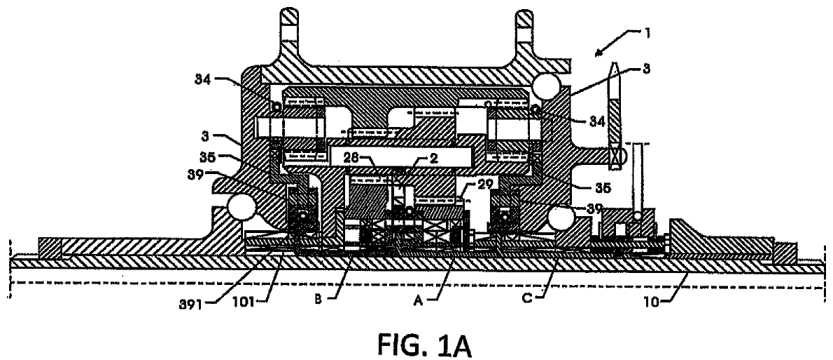

With reference to FIGS. 1 and 1A, a interior clutch-used control mechanism according to the present invention is illustrated. In the embodiment the control assembly includes a first control unit for controlling the fixedness of a sun gear; a second control unit for controlling the engagements of inner gears at two sides and a planet frame for locating a planet gear set; and a third control unit for widely controlling the sun gear or the inner gears and the planet frame. The main feature of the present invention is that the power of control units are mainly from rotary dynamic components of the clutch (such as input rings, inner gears, planet frames, output rings, etc.) by displacements of driving rods (including leftward and rightward displacements, upward and backward displacements, or angular displacements, etc. In the following, leftward and rightward displacements are used in the description of the present invention (but this is not used to confine the scope of the present invention) for controlling the operation of a cam or cam-like component with the use of a displacement of a driven device, for controlling a cam or a cam-like unit to drive the clutch components or with the use of a displacement of a driven device, for controlling the cam or cam-like unit to drive a driven device to rotate or displace for operation a clutching device.

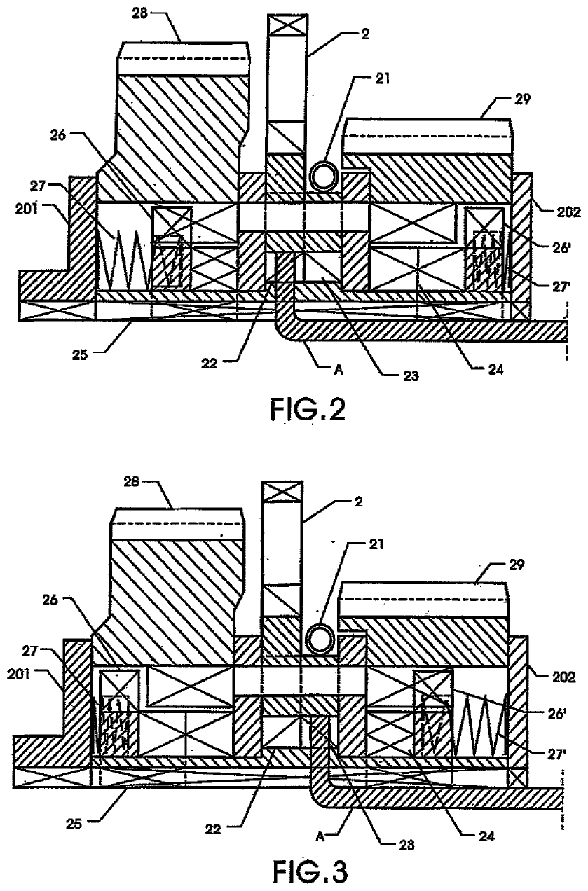

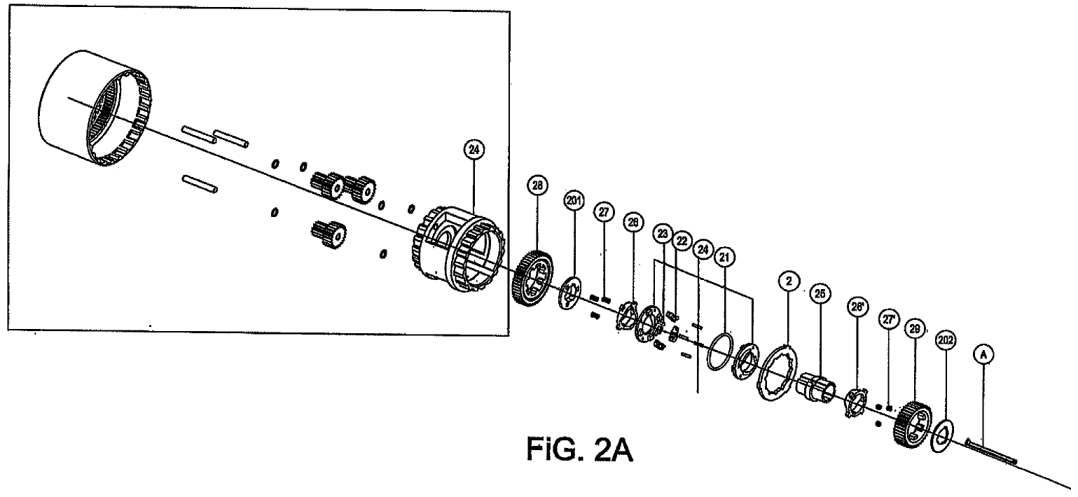

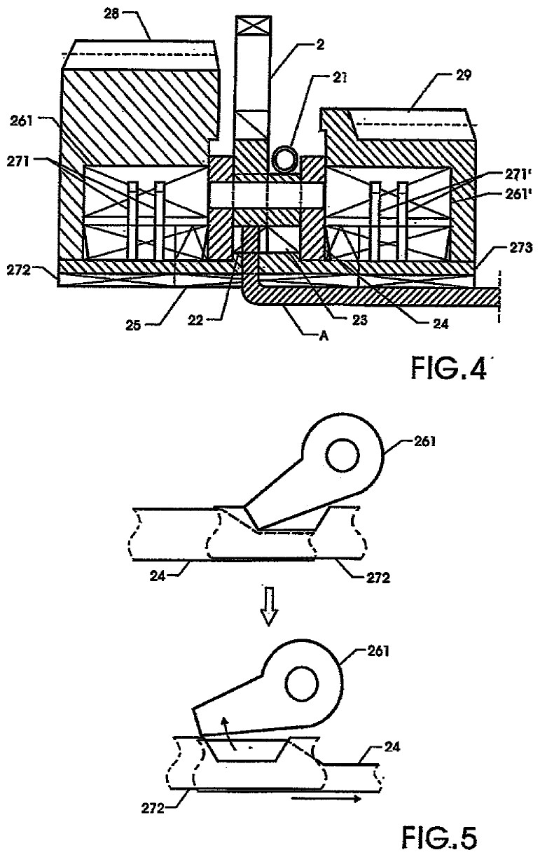

Referring to FIGS. 2, 2A, 3 and 4, it shows an embodiment, where it determines that a sun gear is fixed to an axial clutching control unit or a radial clutching control unit. In this the present invention, the structure is classified as an axial clutching form and a radial clutching form. FIG. 2 shows that a sun gear is fixed to or freely displacement with respect to the axial clutching control unit. FIG. 4 shows that a sun gear is fixed to or freely displacement with respect to the axial clutching control unit.

With reference to FIGS. 2, 2A and 3, the axial clutching control unit of the present invention is illustrated. The axial clutching control unit includes the following elements.

A center shaft 10 of the internal clutch 1 has at least one guide recess 101 for receiving a clutching driving rod.

An actuating sliding seat 25 is installed outside the center shaft 10. A surface of the sliding seat 25 is installed with a left gear 28, a ratchet ring 2 and a right gear 29. The ratchet gear ring 2 is installed between the left gear 28 and the right gear 29.

Between the left gear 28 and the center shaft 10 is installed with a left spring base 201, a left sliding block returning spring 27 and a left actuating sliding block 26 which is resisted by the sliding block returning spring 27 and is controlled by the cam base 24.

Between the right gear 29 and the center shaft 10 is installed with a right spring base 201, a right sliding block returning spring 27′ and a right actuating sliding block 26′ which is resisted by the sliding block returning spring 27 and is controlled by a cam base 24.

The cam base 24 is matched to the ratchet ring 2 and is installed with a first driving rod A. Movement of the cam base 24 will cause to drive one of a lift claw 22, a right claw 23 and a claw return spring 21, wherein the life claw 22 and the right claw 23 are installed on the cam base 23.

With reference to FIGS. 2 and 6, the operation of this embodiment will be described herein. Initially, the driving rod A of the axial clutching unit is at a left side. In FIGS. 1, 2, 3 and 4, the driving rod A moves leftwards and rightwards and in FIG. 6, the driving rod A moves forwards and backwards. Referring to FIGS. 2, 4 and 6, at an initial state, the driving rod A is at a left side and resists against the left claw 22, and another left claw 22 and two right claws 23 resists against the sliding seat 25 so that the left claws 22 do the right claws 23 are not in contact with the ratchet ring 2. At this time, the left gear 28 is fixed and the right gear 29 is freely rotatable. When it is needed to change speed, the left gear 28 is switched to be rotatable freely and the right gear 29 is switched to be fixed.

The process is that: Firstly the driving rod A moves rightwards so that the left claw 22 is ejected upwards to engage to the ratchet ring 2 so as to drive the cam base 24 to rotate. When the cam base 24 rotates, an axial cam pushes the left actuating sliding block 26 to leave from the left gear 28 so that the left gear 28 is free. Then the left sliding block returning spring 27 is compressed so that the left actuating sliding block 26 is ejected by the cam base 24 to move leftwards further.

The cam base 24 rotates continuously so that the by the driving of the right sliding block returning spring 27′, the right actuating sliding block 26′ returns to right side. As a result, the right gear 29 is engaged with the right actuating sliding block 26′.

By above mentioned action as illustrated in FIG. 3, the driving rod A moves leftwards to the initial position as illustrated in FIGS. 2 and 6.

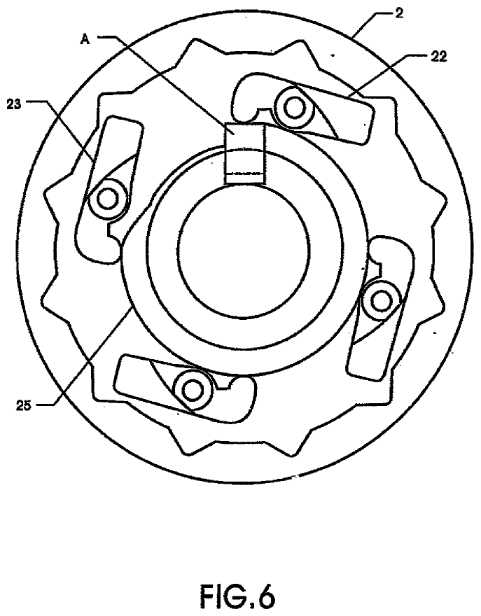

With reference to FIG. 4, a cross sectional view about the radial clutching unit of the present invention is illustrated. In this embodiment, the main structure is like those described above, while the cam of the cam base 24 is radially moved. The left actuating sliding block 26 is changed to a left stop claw 261 and the right actuating sliding block 26′ is changed to a right stop claw 261′. The left sliding returning spring 27 is changed to a left stop claw returning spring 271 and the right sliding returning spring 27′ is changed to a right stop claw returning spring 271′. A left claw base 272 and a right claw base 273 are fixed to a surface of a center shaft 10. The operation of the stop claw 261 is identical to those illustrated in FIG. 5 and the operation principle is also like the above mentioned.

With reference to FIGS. 1 and 6, the above mentioned control unit is performed by the fixedness of the sun gear. Since the fixedness of the ratchet ring 2 is by a rotation unit (such as an input ring, an inner gear, a planet frame, an output ring, etc. which rotates by changing gear). The function of the driving rod A serves to resist the claws 22, 23 not to engage with the ratchet ring 2. Therefore, it is not acted by input torque. Meanwhile, the left claw 22 and the right claw 23 are paired (as a two pair structure illustrated in FIG. 4) so that a 90 degree rotation causes an action. Therefore, the action is sequentially proceeded by a step for each time.

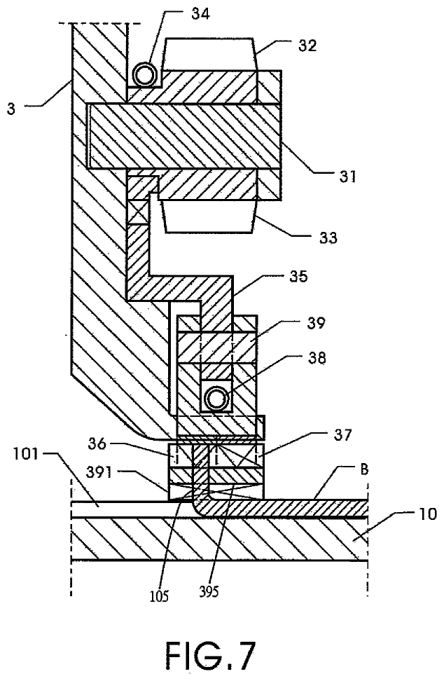

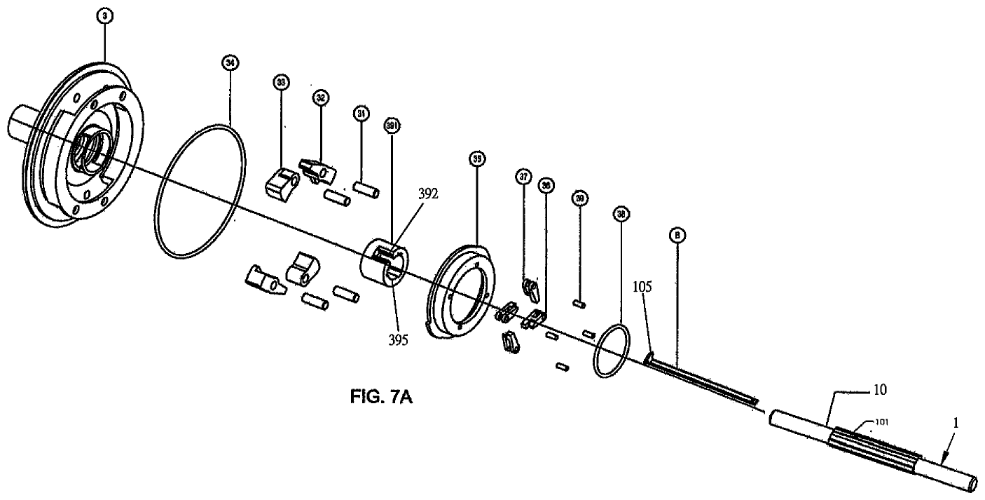

Referring to FIGS. 7 and 7A, the second control unit has a plurality of control claws for the inner gears at two sides and the planet frame according to the present invention is illustrated. By the position of the control claws, the control unit is classified as two kinds. For one kind of the second control unit, the control claws are positioned at a linking device which is reacted with a power rotation unit. For another kind of the second control unit, the control claws are positioned a fixing unit. FIG. 7 shows an embodiment that the control claws are positioned on a linking device. The second control unit includes the following elements.

For embodiment illustrated in FIGS. 1 and 7, a driving rod B is installed on a center shaft 10 of an internal clutch 1. A control claw actuating seat 391 and a rotation ring 3 are installed at an outer side of the center shaft 10. The center shaft 10 has at least one guide recess 101 for receiving the driving rod B. The rotation ring 3 is used as a power rotation unit. The control claw actuating seat 391 is positioned at a center of the rotation ring 3. The control claw actuating seat 391 is fixed on the outer side of the center shaft 10. An inner side of the rotation ring 3 is installed with a plurality of claw shafts 31 for being assembled to a plurality of upper planet power ratchet claws 32 and a plurality of lower planet power ratchet claws 33. Each of the upper planet power ratchet claws 32 is connected to a respective one claw shaft 31. Each of the lower planet power ratchet claws 33 is connected to a respective one claw shaft 31. FIG. 7A shows that there are four claw shafts 31, two upper planet power ratchet claws 32 and two lower planet power ratchet claws 33. A ratchet claw returning spring 34 surrounds an outside of the claw shafts 31. A ratchet claw control panel 35 is installed at an inner side of the upper planet power ratchet claws 32 and the lower planet power ratchet claws 33. The ratchet claw control panel 35 is used as a linking device. The ratchet claw control panel 35 is installed with a plurality of left control claws 36 and a plurality of right control claws 37 and a plurality of controlling claw shafts 39. FIG. 7A shows that the ratchet claw control panel 35 is installed with two left control claws 36 and two right control claws 37 and four controlling claw shafts 39. Each of the left control claws 36 is connected to a respective one controlling claw shaft 39. Each of the right control claws 37 is connected to a respective one controlling claw shafts 39. A claw returning spring 38 is installed at an inner side of the controlling claw shafts 39. An outer side of the control claw actuating seat 391 forms a notch 392 for engaging the driving rod B or each of the left control claws 36.

The control claw actuating seat 391 forms a center through hole 395. An end of the driving rod B is positioned at the center through hole 395 of the control claw actuating seat 391. The end of the driving rod B forms a protruded portion 105.

The object of the control unit serves to control the closing of the upper planet power ratchet claws 32. With reference to FIGS. 7 and 7A, the left control claws 36 and the right control claws 37 are positioned and installed on the ratchet claw control panel 35 and are driven by the ratchet claw control panel 35 to rotate relative to the rotation ring 3.

As shown in FIG. 7, initially, the driving rod B is at a left side of the control claw actuating seat 391. As a result, one of the left control claws 36 is supported and thus does, and thus is filled into the notch 392 of the control claw actuating seat 391. As a result, one of the left control claws 36 is supported and thus does not engaged with the control claw actuating seat 391, while another left control claw 36 and the two right control claws 37 contact a surface of the control claw actuating seat 391. An end of each of the upper planet power ratchet claws 32 forms a cam 321.

As illustrated in the drawing, initially, the driving rod B is at the left side of the control claw actuating seat 391, at this moment, the upper planet ratchet claws 32 opens and the right control claws 37 closes.

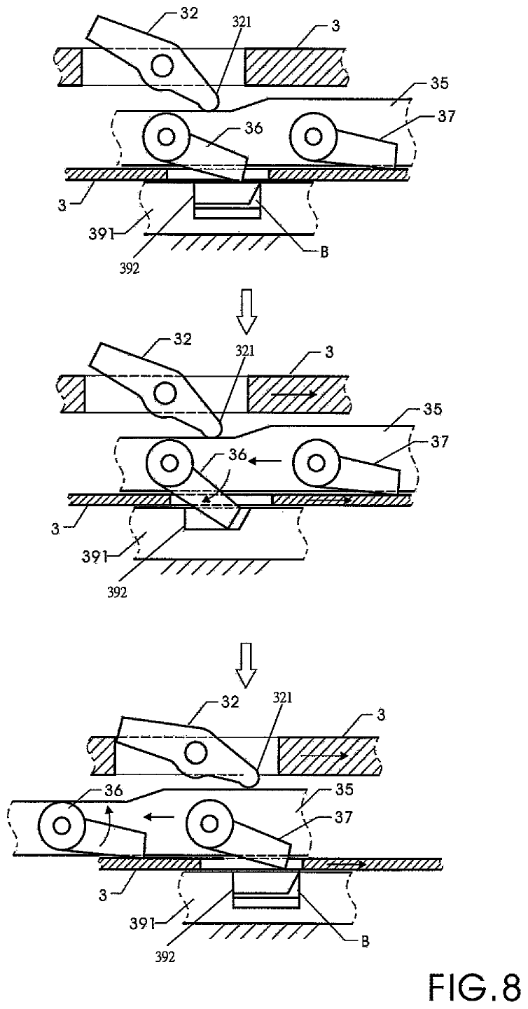

The action for closing the upper planet power ratchet claw 32 is that: the driving rod B moves transversally from a position locating one of the left control claws 36 to a position locating one of the right control claws 37 (referring to FIG. 8, the first and second steps). At this moment, the driving rod B does not support the one of the left control claws 36 and is engaged with the notch 392 of the control claw base 391. Therefore, the ratchet claw control panel 35 is fixed on the rotation ring 3 and rotates with respect to the rotation ring 3.

Rotation of the ratchet claw control panel 35 causes the upper planet power ratchet claw 32 closes. Then the one of the left control claws 36 leaves by the action of the rotation ring 3 which rotates so as to leave from the notch 392 of the control claw actuating seat 391, while the one of the right control claws 37 moves to the notch 392 of the control claw actuating seat 391 to be supported by the driving rod B.

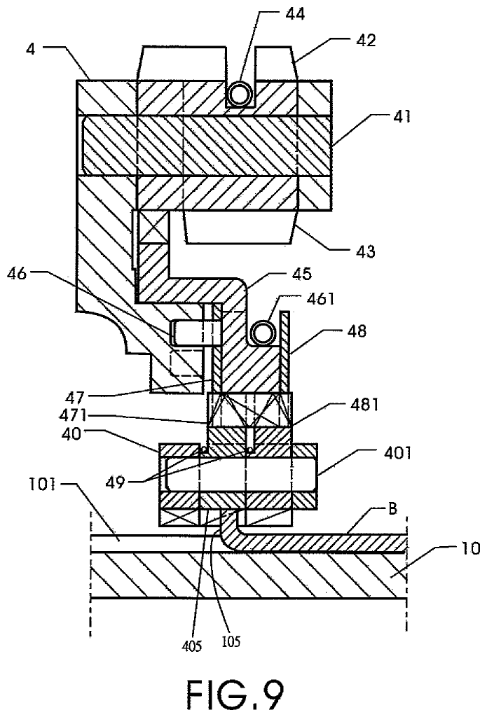

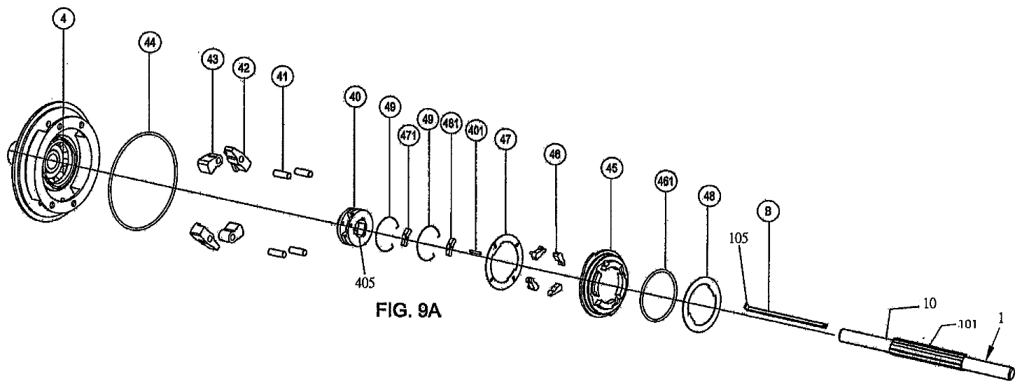

With reference to FIGS. 9 and 9A, an embodiment is illustrated. The embodiment of FIGS. 9 and 9A are similar to the embodiment shown in FIGS. 7 and 7A. The second control unit has a plurality of control claws which are positioned on a fixing unit. In this embodiment, the second control unit includes the following elements.

A driving rod B is installed on a center shaft 10 of an internal clutch 1. A control claw fixing base 40 and a rotation ring 4 are installed on outside of the center shaft 10. The center shaft 10 has at least one guide recess 101 for receiving the driving rod B. The control claw fixing base 40 is positioned at a center of the rotation ring 4. The control claw fixing base 40 is fired with center shaft 10. A control claw shaft 401, a control claw returning spring 49, a left control claw 471 and a right control claw 481 are installed on the control claw fixing base 40. a plurality of upper planet power ratchet claws 42, a plurality of lower planet power ratchet claws 43 and a plurality of controlling claw shafts 41 are installed on the rotation ring 4. FIG. 9A shows that two upper planet power ratchet claws 42, two lower planet power ratchet claws 43 and four controlling claw shafts 41 are installed on the rotation ring 4. Each of the upper planet power ratchet claws 42 is installed with a respective one controlling claw shaft 41. Each of the lower planet power ratchet claws 43 is installed with a respective one controlling claw shaft 41. A ratchet claw returning spring 44 surrounds an outer side of the controlling claw shafts 41. A ratchet claw control panel 45 is installed at an inner side of the upper planet power ratchet claws 42 and the lower planet power ratchet claws 43. A left limiting panel 47 is installed at a left side of the ratchet claw control panel 45. A right limiting panel 48 is installed at a right side of the ratchet claw control panel 45. A returning spring 461 is installed between the ratchet claw control panel 45 and the right limiting panel 48. An end of each of the upper planet power ratchet claws 42 forms a cam 421. The ratchet claw control panel 45 forms a groove 451 for receiving the cam 421 of each of the upper planet power ratchet claws 42.

The control claw fixing base 40 forms a center through hole 405. An end of the driving rod B is positioned at the center through hole 405 of the control claw fixing base 40. The end of the driving rod B forms a protruded portion 105.

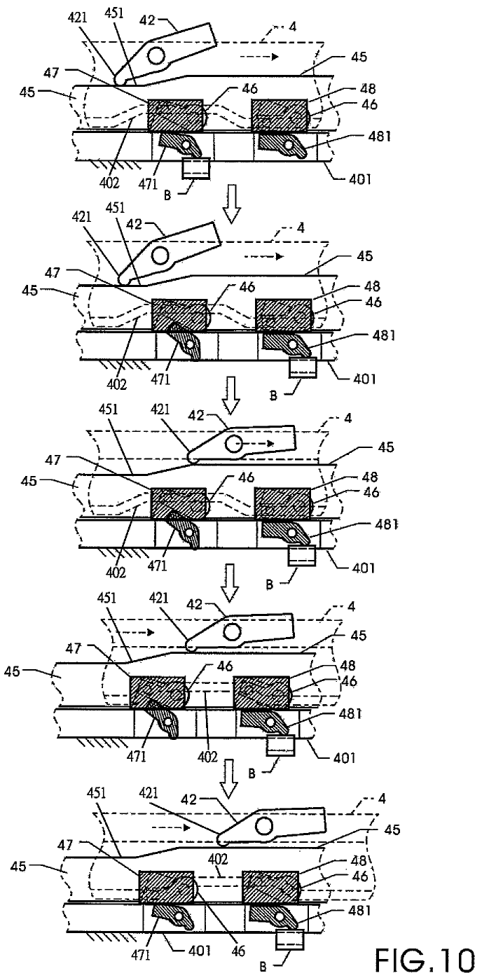

An auxiliary claw 46 is installed between the left limiting panel 47 and the rotation ring 4. As illustrated in the drawing, the control claw fixing base 40 and the rotation ring 4 are at initial positions. In an initial state, the driving rod B is at a position (left side) locating the left control claw 471 and the left control claw 471 is supported by the driving rod B and is not engaged with the ratchet claw control panel 45. At this time, the right control claw 481 is stopped by the auxiliary claw 46 and the right limiting panel 48 and cannot engage the ratchet claw control panel 45. Therefore, the ratchet claw control panel 45 is motionless and has no function of changing speed. When the driving rod B moves, it states to change speed. The operation is illustrated in FIG. 10.

Referring to FIG. 9, when the driving rod B moves from a position (left side) locating the left control claw 471 to a position locating the right control claw 481, the left control claw 471 is engaged with the ratchet claw control panel 45 so that the ratchet claw control panel 45 cannot rotate with respect to the control claw fixing base 40.

As the rotation ring 4 rotates continuously so that the ratchet claw control panel 45 to control the upper planet power ratchet claw 42 to rotate leftwards. Therefore, the upper planet power ratchet claw 42 closes and to leave from a groove 451 at the ratchet claw control panel 45.

When the upper planet power ratchet claw 42 leaves from the groove 451 at the ratchet claw control panel 45, the rotation ring 4 rotates continuously. The auxiliary claw 46 is closed by a track 402 of the rotation ring 4 so that the left control claw 471 returns to a leaving state, that is, the left control claw 471 is prohibited to engaged with the ratchet claw control panel 45. Then the driving rod B is at the position (right stop position) locating the right control claw 481 to resist the right control claw 481 so as to complete a speed changing action.

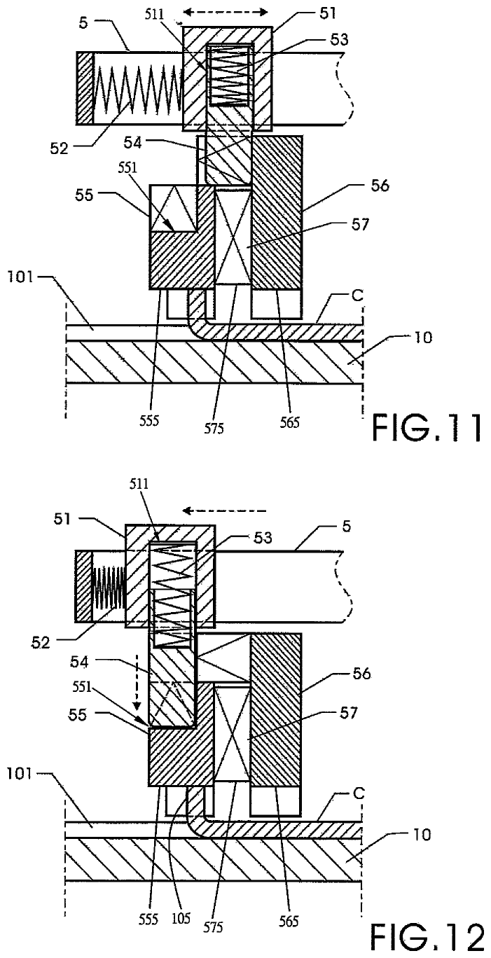

With reference to FIGS. 11 and 11A, an embodiment of the present invention is illustrated. The embodiment of FIGS. 11 and 11A are similar to the embodiment shown in FIGS. 7 and 7A. It shows the third control unit which is widely used to a radial clutching and axial clutching operation. The third control unit includes the following elements.

In this embodiment, a driving rod C is installed on a center shaft 10 of an internal clutch 1. A radial control cam ring 55 and an axial control cam ring 56 are installed on an outer side of the center shaft 10. The center shaft 10 has at least one guide recess 101 for receiving the driving rod C. A spacing ring 57 is installed between the radial control cam ring 55 and the axial control cam ring 56. A power rotation unit 5 is installed with a sliding ring 51 which is used as a linking device. A plurality of axial springs 52 are installed between an outer side of the sliding ring 51 and the rotation unit 5. An interior of the sliding ring 51 is installed with a plurality of pins 54 and a plurality of radial spring 53. Each of the pins 54 is connected to a respective one radial spring 53. The interior of the sliding ring 51 forms a plurality of installing holes 511. Each of the radial springs 53 is installed in a respective one installing hole 511. Each of the pins 54 is positioned between a respective one radial springs 53 and the radial control cam ring 55. The radial control cam ring 55 and the axial control cam ring 56 are installed at an inner side of the sliding ring 51. FIG. 11A shows that there are three axial springs 52, three pins 54 and three radial springs 53. By the displacement of the sliding ring 51, each of the pins 54 is moved to be retained to the radial control cam ring 55 or to the axial control cam ring 56 so as to achieve the object of clutching of the radial clutching or axial clutching operation. a side of the radial control cam ring 55 forms a plurality of grooves 551. Each of the grooves 551 is used to receive a respective one pin 54.

The radial control cam ring 55 forms a center through hole 555. The axial control cam ring 56 forms a center through hole 565. The spacing ring 57 forms a center through hole 575. The driving rod C runs through the center through hole 565 of the axial control cam ring 56 and the center through hole 575 of the spacing ring 57. An end of the driving rod C is positioned at the center through hole 555 of the radial control cam ring 55. The end of the driving rod C forms a protruded portion 105.

When the driving rod C moves to and retained at the radial control cam ring 55, the pins 54 originally positioned to the radial control cam ring 55 are ejected outwards and are driven by the axial springs 52 to move to a left side of the axial control cam ring 56. Therefore, the sliding ring 51 and the axial control cam ring 56 rotate with the rotation unit 5, as those shown in FIGS. 11 and 11A.

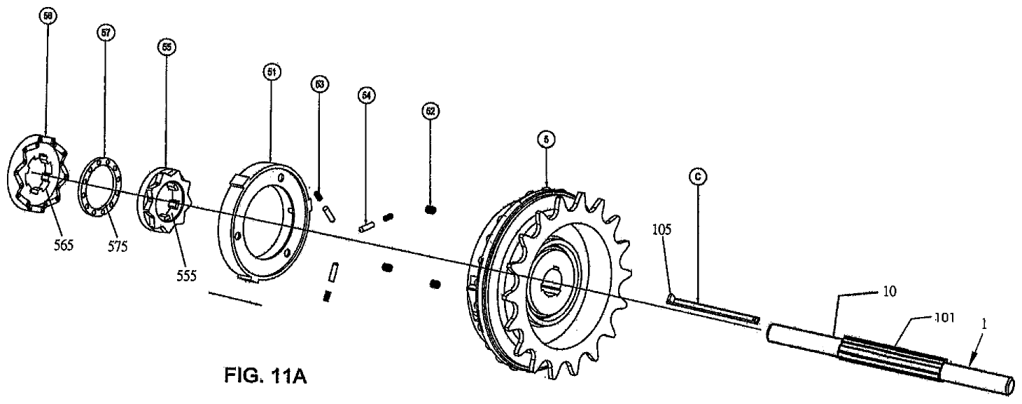

Similarly, when the driving rod C moves to and retained at the axial control cam ring 56, each of the pins 54 is ejected inwards by the respective one radial spring 53 and engages to the radial control cam ring 55. Therefore, the sliding ring 51 and the radial control cam ring 55 rotate with the rotation unit 5, as those shown in FIG. 12.

In summary, in the control unit of an internal clutch, by power rotating components (such as input rings, inner gears planet frames, output rings, etc.) which rotates as the internal clutch and cam or cam-like component, clutching components are controlled, such as to control the fixing of a sun gear, to control the engagements of the internal gear and planet gear. That is, using a cam or cam-like components to drive a driven device to rotate or displace so as to control the clutch to change gears

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An interior clutch-used control mechanism comprising:
a driving rod (B) being installed on a center shaft (10) of an internal clutch (1);
a control claw actuating seat (391) and a rotation ring (3) being installed at an outer side of the center shaft (10); the rotation ring (3) being used as a power rotation unit; the control claw actuating seat (391) being positioned at a center of the rotation ring (3); the control claw actuating seat (391) being fixed on the outer side of the center shaft (10);
an inner side of the rotation ring (3) being installed with a plurality of claw shafts (31) for being assembled to a plurality of upper planet power ratchet claws (32) and a plurality of lower planet power ratchet claws (33); each of the upper planet power ratchet claws (32) being connected to a respective one claw shaft (31); each of the lower planet power ratchet claws (33) being connected to a respective one claw shaft (31);
a ratchet claw returning spring (34) surrounding an outside of the claw shafts (31);
a ratchet claw control panel (35) being installed at an inner side of the upper planet power ratchet claws (32) and the lower planet power ratchet claws (33); the ratchet claw control panel (35) being used as a linking device; the ratchet claw control panel (35) being installed with a plurality of left control claws (36) and a plurality of right control claws (37) and a plurality of controlling claw shafts (39); each of the left control claws (36) being connected to a respective one controlling claw shaft (39); each of the right control claws (37) being connected to a respective one controlling claw shafts (39); and
a claw returning spring (38) being installed at an inner side of the controlling claw shafts (39); the left control claws (36) and the right control claws (37) being positioned and installed on the ratchet claw control panel (35) and driving the ratchet claw control panel (35) to rotate relative to the rotation ring (3).

2. The interior clutch-used control mechanism as claimed in claim 1, wherein initially, the driving rod (B) is at a left side of the control claw actuating seat (391) and is filled into a notch (392) of the control claw actuating seat (391); as a result, one of the left control claws (36) is supported and thus does not engaged with the control claw actuating seat (391), while other left control claws (36) and the right control claws (37) contact a surface of the control claw actuating seat (391); at this moment, the upper planet ratchet claws (32) opens and the right control claws (37) closes;
wherein the action for closing the upper planet power ratchet claw (32) is that the driving rod (B) moves transversally from a position locating one of the left control claws (36) to a position locating one of the right control claws (37); at this moment, the driving rod (B) does not support the one of the left control claws (36) and is engaged with the notch (392) of the control claw base (391); therefore, the ratchet claw control panel (35) is fixed on the rotation ring (3) and rotates with respect to the rotation ring (3); and rotation of the ratchet claw control panel (35) causes the upper planet power ratchet claw (32) closes; then the one of the left control claws (36) leaves by the action of the rotation ring (3) which rotates so as to leave from the notch (392) of the control claw actuating seat (391), while the one of the right control claws (37) moves to the notch (392) of the control claw actuating seat (391) to be supported by the driving rod (B).

3. The interior clutch-used control mechanism as claimed in claim 1, wherein the plurality of claw shafts (31) are four claw shafts (31); the plurality of upper planet power ratchet claws (32) are two upper planet power ratchet claws (32); and the plurality of lower planet power ratchet claws (33) are two lower planet power ratchet claws (33).

4. The interior clutch-used control mechanism as claimed in claim 1, wherein the plurality of left control claws (36) are two left control claws (36); and the plurality of right control claws (37) are two right control claws (37) and the plurality of controlling claw shafts (39) are four controlling claw shafts (39).

5. The interior clutch-used control mechanism as claimed in claim 1, wherein the center shaft (10) has at least one guide recess (101) for receiving the driving rod (B).

6. The interior clutch-used control mechanism as claimed in claim 1, wherein an end of each of the upper planet power ratchet claws (32) forms a cam (321).

7. The interior clutch-used control mechanism as claimed in claim 1, wherein an outer side of the control claw actuating seat (391) forms a notch (392) for engaging the driving rod (B) or each of the left control claws (36).

8. The interior clutch-used control mechanism as claimed in claim 1, wherein the control claw actuating seat (391) forms a center through hole (395); an end of the driving rod (B) is positioned at the center through hole (395) of the control claw actuating seat (391).

9. The interior clutch-used control mechanism as claimed in claim 8, wherein the end of the driving rod B forms a protruded portion (105).
